(19) United States
(12) Patent Application Publication
(10) Pub. No.: US 2021/0174395 A1
(43) Pub. Date: Jun. 10, 2021

(54) SYSTEM AND METHOD FOR LOCATION-BASED PRODUCT SOLUTIONS USING ARTIFICIAL INTELLIGENCE

(71) Applicant: GroundLevel Insights Inc., Pickering (CA)

(72) Inventor: Asif R. Khan, Pickering (CA)

(21) Appl. No.: 17/118,084

(22) Filed: Dec. 10, 2020

Related U.S. Application Data
(60) Provisional application No. 62/946,054, filed on Dec. 10, 2019.

(51) Int. Cl. G06Q 30/02; G06F 16/29; G06Q 30/06; G06N 5/02

(52) U.S. Cl. CPC G06Q 30/0261; G06F 16/29; G06N 5/02; G06Q 30/0271; G06Q 30/0631; G06Q 30/0255

(57) ABSTRACT

Systems, methods, and computer-readable storage media for using first and third party data as inputs to an Artificial Intelligence (AI) engine which provides suggestions regarding product placement and marketing. A system can receive location data for the mobile devices carried by individuals, as well as data associated with a venue, and normalize the respective data to a common format. The system can the aggregate the data, use the aggregated data as inputs to an AI engine, and generate suggestions for the venue based on correlations identified by the AI engine.

### BACKGROUND

### 1. Technical Field

The present disclosure relates to location-based monitoring systems, and more specifically to using artificial intelligence with location data, such as that provided by a user's mobile devices to identify correlations between locations visited by a mobile computing device and products, a user's activities, or other user events at those locations.

### 2. Introduction

Telecommunication companies regularly track locations of cellular phones and cell phone usage. For example, a telecommunication company operating a cell tower may track how many phones are “pinging” or otherwise attempting to communicate via the tower, overall bandwidth and demand on the tower resources, and the churn (new devices appearing and old devices leaving) of devices with respect to the tower. The telecommunication company can then use this data to determine if or when a new cellular tower is needed. For non-telecommunication companies or venues, determining the number of possible customers within an area can be challenging, as can identifying when those customers would have interest in a given product, venue, or event. One solution uses sensors, RFIDs, and/or cameras to detect and count individual people as they enter/leave a building or other venue. For an individual retailer, the retailer can then use transaction data to correlate the movement or detection of individuals with the sales of actual products. Based on those correlations, the individual retailer can make determinations about when certain products are sold, and from that information determine when to stock their store with various products.

However, such systems do not provide a venue-centric perspective to identify correlations based on movement of users prior to or after visiting a given venue. The data available is not parsed or considered from the perspective of a given venue.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the problem of how to determine correlations using both first party and third party data, where the data collected is not specific to a given retailer or venue, but is instead associated with a given geographic area. An exemplary method according to this application can include: receiving, at a server, location data for a plurality of mobile devices carried by individual users, the location data comprising global positioning system (GPS) coordinates for each mobile device in the plurality of mobile devices over a period of time, the location data constrained to a predefined geographic region; receiving at the server from at least one venue within the predefined geographic region: geofence data associated with the at least one venue; person detection sensor data generated by at least one sensor at the at least one commercial venue; and point of sale data for the at least one venue during the period of time; normalizing, via a processor of the server, the location data, the geofence data, the person detection sensor data, and the point of sale data into a common data format, resulting in normalized location data, normalized geofence data, normalized sensor data, and normalized point of sale data; aggregating, via the processor, the normalized location data, the normalized geofence data, the normalized sensor data, and the normalized point of sale data, resulting in aggregated normalized data; identifying, via the processor executing an artificial intelligence engine on the aggregated normalized data and the geofence data, at least one predicted behavior of a human being; generating, via the processor, a suggestion to the at least one venue based on the at least one predicted behavior of a human being; and transmitting, from the server, a customized advertisement, where the customized advertisement is generated based on the suggestion.

An exemplary system configured according to this disclosure can include: a processor; and a non-transitory computer-readable storage medium having instructions stored which, when executed by the processor, cause the processor to perform operations comprising: receiving, location data for a plurality of mobile devices carried by individual users, the location data comprising global positioning system (GPS) coordinates for each mobile device in the plurality of mobile devices over a period of time, the location data constrained to a predefined geographic region; receiving from at least one venue within the predefined geographic region: geofence data associated with the at least one venue; person detection sensor data generated by at least one sensor at the at least one commercial venue; and point of sale data for the at least one venue during the period of time; normalizing the location data, the geofence data, the person detection sensor data, and the point of sale data into a common data format, resulting in normalized location data, normalized geofence data, normalized sensor data, and normalized point of sale data; aggregating the normalized location data, the normalized geofence data, the normalized sensor data, and the normalized point of sale data, resulting in aggregated normalized data; identifying, by executing an artificial intelligence engine on the aggregated normalized data and the geofence data, at least one predicted behavior of a human being; generating a suggestion to the at least one venue based on the at least one predicted behavior of a human being; and transmitting a customized advertisement, where the customized advertisement is generated based on the suggestion.

An exemplary non-transitory computer-readable storage medium configured according to this disclosure can have instructions stored which, when executed by a computing device, cause the computing device to perform operations including: receiving, location data for a plurality of mobile devices carried by individual users, the location data comprising global positioning system (GPS) coordinates for each mobile device in the plurality of mobile devices over a period of time, the location data constrained to a predefined geographic region; receiving from at least one venue within the predefined geographic region: geofence data associated with the at least one venue; person detection sensor data generated by at least one sensor at the at least one commercial venue; and point of sale data for the at least one venue during the period of time; normalizing the location data, the geofence data, the person detection sensor data, and the point of sale data into a common data format, resulting in normalized location data, normalized geofence data, normalized sensor data, and normalized point of sale data; aggregating the normalized location data, the normalized geofence data, the normalized sensor data, and the normalized point of sale data, resulting in aggregated normalized data; identifying, by executing an artificial intelligence engine on the aggregated normalized data and the geofence data, at least one predicted behavior of a human being; generating a suggestion to the at least one venue based on the at least one predicted behavior of a human being; and transmitting a customized advertisement, where the customized advertisement is generated based on the suggestion.

### BRIEF DESCRIPTION OF THE DRAWINGS

FIG. 1 illustrates an example system overview;

FIG. 2 illustrates an example algorithm;

FIG. 3 illustrates an example embodiment of the AI engine;

FIG. 4 illustrates an example embodiment of the suggestion engine;

FIG. 5 illustrates examples of system components interacting to provide custom advertisements;

FIG. 6 illustrates an example method embodiment; and

FIG. 7 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

One exemplary, non-limiting, practical application to the technical problem noted above is to collect first party data, such as sensor data and point-of-sale/transaction data, collect third party data, such as data from GOOGLE Maps, normalize the data to a common format, aggregate the normalized data together, submit the aggregated normalized data into an Artificial Intelligence (AI) engine, and receive suggestions about products, services, or correlations from the AI engine. Consider the following example.

A “fast-fashion” clothing store is located in an outdoor mall and receives a new stock of inventory every month. The amount and type of inventory allocated to the store each month is determined based on previous sales at the store, as well as aspects such as foot traffic, seasonality, marketing/brand value, etc. However, the clothing store has insufficient data to make any determinations about what type of products to inventory based on where the shoppers were before they entered the clothing store, where the shoppers went after they visited the clothing store, and/or what items they may have purchased at those other locations. In addition to having insufficient data, the clothing store is also deficient in the methodology/algorithms which define how the clothing store would use such data, if provided, to modify current inventory demands.

The present disclosure addresses both data acquisition and the algorithms for modifying the data in such circumstances. In the case of the clothing store (or a company operating on behalf of the clothing store) performing concepts disclosed herein, the clothing store can continue to use first party data which they (the clothing store) generate. Exemplary first party data can include point of sale data identifying products sold in a given transaction, motion detector information identifying when customers enter/leave a store, cameras identifying when customers enter/leave a store. While preferably systems configured according to this disclosure do not engage in facial recognition, in some configurations the cameras can be used to detect/predict gender, age, and/or other demographic information about the customer. In other configurations, facial recognition, or otherwise detecting the identity of the user, can be used to further draw conclusions about the location data. Similarly, the systems disclosed herein obfuscate the identity of a customer with respect to any given product sale or transaction, without regard to whether other systems may identify such connections.

Having obtained first party data, the clothing store (or a company operating on behalf of the clothing store) also collects third party data. One example of third party data collected is mobile phone (or other mobile computing device) location data. Mobile computing device, as disclosed herein, is any type of computing device which is easily carried or moved about by a human user, including laptops, tablet computers, smartphones, mobile phones, smart watches, wearable computing devices, etc. The location data can be restricted to only individuals who enter the store within a predefined period of time, and/or all individuals who come within a certain radius or predetermined geographic area (e.g., defined by a geofence). For example, in the case of the clothing store at the outdoor mall, location data could be provided for all mobile computing devices within a period of time which come within 500 meters of the clothing store, or for all mobile computing devices which enter the mall grounds. The location data can, for example, be provided by users through the use of a smartphone application associated with the clothing store, another vendor, or other entity, where the individual users/owners of the smartphone give explicit permission to collect location information about the owner of the smartphone's location. In some configurations, the application can provide for revenue sharing among multiple retailers or provide coupons/discounts to the users. In another example, the location data of mobile devices can be provided by cellular providers. Regardless of how the clothing store obtains the location data, the location data will be sufficiently aggregated and “cleaned” as to remove identification of a single individual. For example, if there is a single user visiting stores within the outdoor mall in a particular order, that user's particular location data may be withheld from the location data of others until there is sufficient additional location data to mask the individual's identity so as to not identify the individual.

Third party data can also include social media data obtained from sources such as, for example, INSTAGRAM, FACEBOOK, or SNAPCHAT. In such configurations, the clothing store (or a company operating on behalf of the clothing store) searches for hashtags, mentions, locations, etc., which identify or reference the clothing store, or which identify or reference venues or locations near the clothing store. For example, if there is an ice cream store near the clothing store, the third party social media data may identify those posts which tag the ice cream store. Where locations are provided in the social media post, the time, location, and various facts about the generator of the social media post (followers/friends, gender, age, etc.), can be included as the “social media data.”

Third party data can also include map data from, for example, GOOGLE MAPS or APPLE MAPS. The map data can include location data regarding structures and/or venues (parks, businesses, residences, etc.). In some cases, this location data can be in the form of geo-fences which define latitude and longitude boundaries of the respective structures/venues. In other cases, the location data can be in the form of a single combined latitude and longitude which marks the location of a structure or venue.

The clothing store, upon obtaining the first party and third party data, can normalize the data such that it is in a single common format.

Once all of the first party data and the third party data are in a common format, the data are combined together (i.e., aggregated), and the aggregated data is entered into an Artificial Intelligence (AI) engine. The AI engine parses the data, running iterative regressions on the data and identifying correlations between aspects of user's location data, likely purchases or activities at those locations, and modifying the code/weights of the AI engine based on results or respective regressions. For example, the AI engine may identify a pattern indicating that most of the people who actually purchase an item at the clothing store first visit another clothing store for a brief moment (indicating that a purchase at that store was unlikely) before visiting the clothing store, then immediately visit a book store after making a purchase. Based on that information, the AI engine (or a suggestion engine operating with the AI engine) can provide the suggestion to highlight, in marketing or otherwise, various aspects in which the clothing store is an improvement over the first-visited clothing store. Likewise, because of the visit to the bookstore, the system may suggest contracting with the bookstore to provide a coupon at the bookstore to anyone who makes a purchase at the clothing store.

Regarding data collection and aggregation, first party data from cameras, beacons, motion detectors, etc., can be directly sent to a database as the information is collected, whereas third party data may be provided to the system or a database on a periodic basis (such as daily or weekly). Examples of third party data can include can include information from cameras, beacons, motion detectors, etc., which are owned and/or operated by third parties. For example, mobile phone data is owned by telecommunications companies, and may be provided to the system on a periodic basis which depends on the provider and their security/privacy policies.

Similarly, with regard to data privacy, the system may record data but have a mandatory waiting period before the data can be used or analyzed. For example, while a user is shopping the system may record various first and third party information about the user's location and behavior, however the system may be prohibited from acting on that data for a predetermined amount of time (such as a day). Information, such as video analysis data from surveillance footage, may be partially used, where analysis of the video data by the AI engine may be delayed while general surveillance use of the video data may be allowed. For example, the surveillance video footage may be used to determine if people are complying with mask or other clothing requirements in real time, but analysis of the video footage may be used a day or two later to determine patterns of behavior associated with the users.

As the data is collected from disparate sources, it will need to be normalized into a format which can be interpreted by the AI/suggestion engine(s). With location data from cameras/motion detectors, etc., this can be latitude/longitude coordinates. However, raw data from cellular towers is not provided in latitude/longitude formats, and there is no guarantee that triangulation from multiple cellular towers will be available. Instead, with regard to cellular tower data, the tower data can include the tower name/identification, a time when the user entered the tower range, a time when the user left the tower range, etc. Likewise, the location data from cameras/motion detectors/etc. can include times where users were entering and leaving stores and other locations, allowing the system to determine “hand off” points between various locations.

As an example, if a user John visited a store, the system could detect him at the store entrance using a camera. As John enters the store, Bluetooth or WiFi devices can detect when he enters (or more precisely, his cellphone) and leaves different portions of the store, effectively allowing John to be track throughout the store. Likewise, if the store has motion detectors or cameras internal to the store, information from those cameras or detectors can be used to track John's movements within the store. If John's mobile device is detected and known to the system, the system can link John's movements in the store to patterns previously detected on previous occasions (at this store or at other stores). Overtime, the system can match movement patterns that overlap and connect disparate data sources (such as GPS, WiFi, BTLE (BlueTooth Low Energy), NFC (Near Field Communications), etc.

The Artificial Intelligence (AI) engine can use the stored data to create metadata for each user based on their behavior, and can assign the user to different categories based on that behavior or other factors. Exemplary metadata which could be attached to the user profile can identify aspects of the user behavior (e.g., always gets ice cream before visiting a certain store). Exemplary categories which could be assigned to a user can include demographic information (age, gender, etc.), as well as the type of stores frequented (posh v. thrifty, food v. retail, etc.).

In addition to creating metadata and assigning categories to users, the AI engine can use the normalized data stored in the database to run a time series prediction algorithm (such as PyTorch or Tensorflow) which predicts where users are likely to go. The time series prediction algorithm executes a neural network made of nodes and connections between the nodes, where the connections have weights which are adjusted over time based on additional data received. This modification over time, or machine learning, allows the time series prediction to adjust to patterns or behaviors identified for single users and/or groups of users. Here, the nodes of the neural network can be specific/known locations, and the connections between the nodes can be the likelihood that the user will visit another location next. To train the neural network, the system can be provided data identifying where multiple users travelled, extract the locations and route which the individual users took, and perform a sensitivity analysis on the data, with the sensitivity analysis identifying the likelihood of a user visiting each point from a given point, or the likelihood of visiting a point (or points) given a history of visiting multiple previous points (such as in a time series prediction). For example, the sensitivity analysis can execute models (such as a one-at a time test, a derivative-based local method, regression analysis, variance-based method, screening, scatter plots, etc.) to identify how a given input/variable affects the likelihood of a specific condition (such as visiting a future location or behaving in a certain way).

With the neural network (which is made of nodes and connections between the nodes, where the connections between the nodes are weighted based on the correlations identified by the sensitivity analysis), the neural network is converted to computer executable code, resulting in an artificial intelligence algorithm, which may or may not be the entirety of the AI engine.

With the neural network constructed, the AI engine can enter the current location (or history of locations) of a current user and predict future locations, future paths, future behavior (such as future purchases, predicted mask wearing, predicted movement, predicted conversations, etc.). Given additional data, the neural network can be adjusted. More specifically, an updated sensitivity analysis on the data can be performed, such that the weights of the connections between nodes in the neural network can change based on the additional data received, reflecting updated likelihoods of a user travelling to a subsequent location (or other likely behavior). In performing the updated sensitivity analysis on the data, some configurations may exclude outdated portions of the training data can be excluded, whereas in other configurations all data received to that date may be analyzed.

After being trained, the AI engine executes the neural network by inputting the current location or current history of locations to the neural network, with the output being the likelihood of the user subsequently visiting one or locations. For example, the neural network can be a “sequence-to-sequence” network made up of (at least) two sub-neural networks: an encoder and a decoder. The encoder receives, for each trip of a user: a beginning and various classes representing locations, as well times/dates when the visits occurred. As additional visits are made, that additional data is added, resulting in a multi-dimensional vector indicating locations and associated times, with transitions to subsequent locations and associated times. These multi-dimensional vectors can be referred to as “embeddings.”

To create an embedding for an individual user, the system can take the embeddings of all the user trips (dimension N), the user country (dimension M), and the user's metadata (dimension P). The system can append them to one another, to create the user's embedding (dimension N+M+P). The system can then input the user's embedding into a fully connected layer, which in turn creates a new embedding (dimension Q). Using the triplet loss function, these embeddings can be pushed further apart or moved closer together.

In some configurations, the embeddings of multiple trips can be averaged together, resulting in a singular embedding which represents either a single user's general patterns, or (if the trips are from multiple users) can represent the general patterns of multiple users. Within a given embedding, whether representing an individual or multiple users, vectors that are closer to one another can indicate higher similarity, whereas the vectors that are more distinct likewise represent a higher level of difference. For example, if a store is visited by X number of people, the system can look at the people similar to those X people within the Q dimension vector space who have not visited the store, and an advertiser should target those people because they have similar attributes to those who have visited the store.

The AI engine can also provide, as an output, a likely path that a given user is likely to follow based on their previous locations. That is, if the user has previously visited stores A and B (in that order), the AI engine can predict that the user is likely to next visit stores C and D, in that order. If the user had visited the same stores (A and B) in reverse order, the system may predict that the user will still visit stores C and D, but in a distinct order (e.g., D, then C). The path output by the AI engine can be combined with the behavioral projections based on previous locations visited by the user, based on previously detected behavior of the user, and/or based on demographic information about the user. Another potential output of the AI engine is a heat map, indicating the commonly visited locations.

This output from the AI engine can then be input to a “suggestion engine,” (which may be part of the AI engine, or may be a separate component) which can make recommendations for advertisers, vendors, or other entities based on the predicted route, behavior, or characteristics of the user. For example, the suggestion engine may recommend to an advertiser that after the user has visited a dessert store the user is likely to be ready to spend money on clothing. The advertiser in turn can use that recommendation to generate a customized advertisement based on the recommendation. For example, the advertiser may cause an electronic billboard near the dessert store to display a discount or sale for a nearby clothing store. In another example, the AI engine may predict that the user is likely to remove their facemask at a certain location, and the suggestion engine may suggest a reminder at a that location. The receiving entity can receive that suggestion, then generate a customized reminder to be audibly broadcast near that location. Alternatively, the receiving entity can transmit the customized reminder to an electronic poster board at that location to display the customized reminder.

Training the suggestion engine can be done using the data stored in the database, such as POS data and location data, as well as data such as inventory, shift hours, foot traffic data, etc. This information can be analyzed using boosted clustering modeling, collaborative filter modeling, and/or regression modeling.

Clustering models can be used to segment out different types of users by using K-means analysis and cluster sum of squares, thereby obtaining an optimal number of cluster values. Customer movement, POS data, and customer loyalty data can be used to train clustering models.

Collaborative filtering can be used to recommend cross sell/up sell/bundling promotions. Data from POS systems can be used to train a collaborative filter model using a centered k-nearest neighbor for determining items and a grid-search to try all combination of parameters, thereby obtaining the best set of parameters for the given data. In some respects, this is a multi-dimensional optimization, where the suggestion offered is based on multiple dimensions, which may include one or more outputs from the AI engine, as well as data about the user, nearby stores, inventory, etc.

A k-means cluster with a multi-armed bandit (MAB) model can be used to build a promotion/coupon selection/targeting model. The promotion/coupon selection/targeting model can identify which offers result in immediate purchases, which offers lead to future purchases, and which offers are ignored. For example, the MAB model can use K-machines to determine the highest/best payoff (a purchase or conversion) in a given round of simulations, thereby making the best decision on the exploitation/exploration trade-off

The suggestion engine executes one or more of these models using, as inputs, the outputs of the AI engine, and provides the resulting suggestion data to one or more advertisers, who can tailor advertising based on the suggestions received. In some configurations these tailored advertisements can be sent directly to the mobile devices, whereas in other configurations the tailored advertisements can be generated and sent to electronic posters or signs around the shopping area. In some configurations the changes made by advertisers based on the outputs of the AI/suggestion engines can occur in realtime (such as when the users are within a shopping area), whereas in other configurations the changes made by advertisers occurs after a “cooldown” time after a last piece of data. This cooldown time can prevent individuals from feeling that advertisers are directly targeting a single individuals as they meander a shopping area.

This technology and improvement is not limited to a retail location and products. While the principles and concepts disclosed herein can be applied to retail locations and/or products, the principles and concepts disclosed herein can also be applied to other types of locations, such as non-retail venues, buildings, and/or transportation hubs (airports, subway stations, train stations, ports, etc.). Other non-exclusive examples of retails locations for which the principles and concepts disclosed herein can be applied include restaurants, cannabis retailers, pharmacies, technology retailers, etc.

Having disclosed a general example of the operating concepts disclosed herein, the application turns to the specific examples provided in the figures.

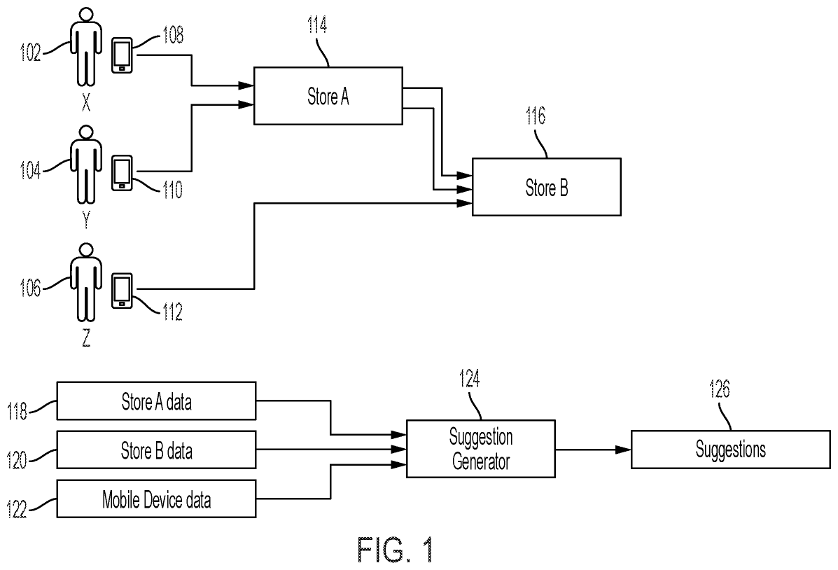

FIG. 1 illustrates an example system overview. In this example, several users X 102, Y 110, and Z 112 each have a mobile device 108, 110, 112. As the users 102, 104, 106 move about, their mobile devices 108, 110, 112 record the locations where the users 102, 104, 106 visit. As illustrated, users X 102 and Y 104 visit store A 114, and then visit store B 116, whereas visit Z 106 goes directly to store B 116.

In this example, store A 114 provides store A data 118, store B 116 provides store B data 120, and the respective mobile devices 108, 110, 112 provide mobile device data 122. The mobile device data 122 can, for example, include the location data of the respective mobile devices 108, 110, 112, where each mobile device 108, 110, 112 has a GPS receiver and the location data contains latitude and longitude information. The store data 118, 120 can, for example, include information from sensors in the store, the information identifying when customers come and go from the store, when purchases are made, what employees were working at certain times, etc.

The store data 118, 120 and the mobile device data 122 can be entered as inputs into a suggestion generator 124, which outputs suggestions 126 for one or more entities about how they can use the collected data to provide an improved product or service. The suggestion generator 124 uses an AI engine to iteratively improve the suggestions 126 provided based on continued observations.

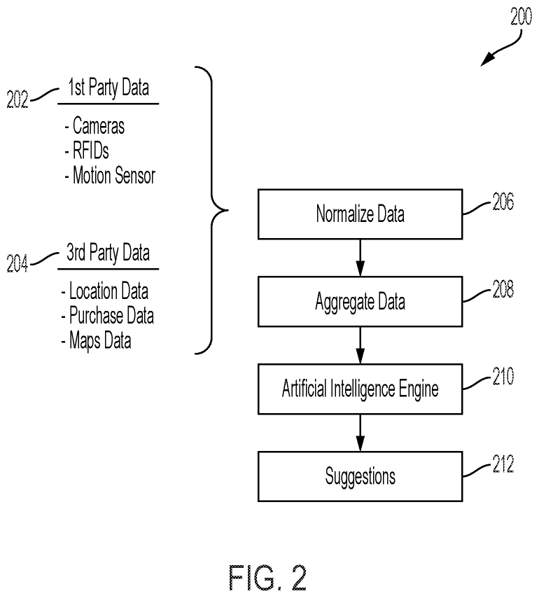

FIG. 2 illustrates an example algorithm 200 which could, for example, be part of the suggestion generator 124 of FIG. 1. In this example, two types of data, first party data 202 and third party data 204 are illustrated. The first party data 202 includes data which may be directly captured by a venue, such as a retail location. In this example, the first party data 202 includes data from cameras, RFIDs (Radio Frequency Identifications), and motion detectors. Other types of first party data 202 may also include marketing information (advertisements, coupons, special offers, etc.).

The system normalizes 206 the first party data 202 and the third party data 204, such that all of the data can be aggregated together, then performs the actual aggregation 208. The resulting aggregated data is submitted to an AI engine 210, which identifies correlations among the data using one or more regressions, modifying the AI engine 210 algorithm (that is, modifying the AI engine code executed by the processor) based on the result of the one or more regressions, and outputs one or more suggestions 212 to the user. The AI engine 210 can also control/be associated with the data collection, normalization 206, and aggregation 208 processes. In making the correlations, the AI engine 210 can, for example, determine that an individual spent a certain amount of time within a geo-fenced location, and because of that time spent make ancillary determinations. For example, if the geo-fenced location is a retail store, and the individual spent an amount of time in that retail store which is longer than a predetermined amount of time, the AI engine 210 can generate a high probability that an item was purchased in the store. The AI engine 210 can then use that probability in generating the suggestions 212.

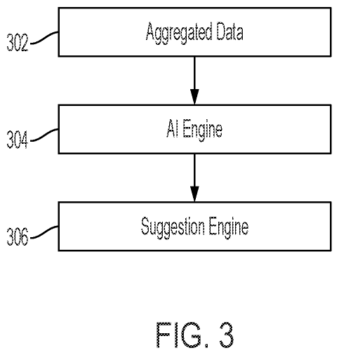

FIG. 3 illustrates an example embodiment of the AI engine 304. The AI engine 304 receives aggregated data 302, and outputs data to the suggestion engine 306, which uses the correlations identified by the AI engine 304 to make suggestions to a user, retailer, venue, or other user of the system. In some configurations, the suggestion engine 306 can be part of the AI engine 304.

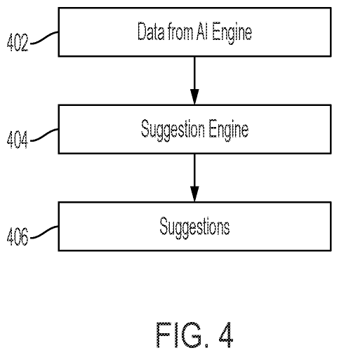

FIG. 4 illustrates an example embodiment of the suggestion engine 404, which converts the correlations made by the AI engine into concrete proposals which, based on data from the AI engine 402, would result in an improvement to the venue, retailer, user, or other entity employing the system. The suggestions can be formed using premade templates which are then modified based on the identified correlations. The resulting suggestions 406 can then be evaluated or followed by that entity.

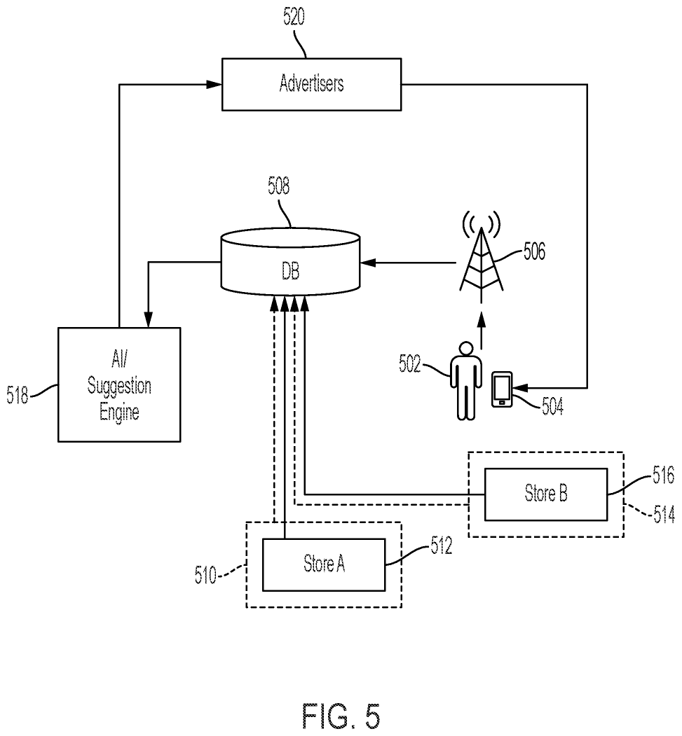

FIG. 5 illustrates examples of system components interacting to provide custom advertisements. In this example, a human being 502 with a mobile device 504 enters a shopping area. Examples of the mobile device 504 can include cell phones, smart phones, laptops, tablets, smart watches, smart glasses, and/or any other mobile computing device capable of wireless communications and processing computer-executable code. As the human 502 enters and meanders about the shopping area, a nearby cellular tower 506 identifies that the human being's 502 mobile device 504 is nearby. Information associated with the mobile device 504 location can be relayed from the cellular tower 506 to a database 508. In addition to cellular towers 506, this wireless geolocation of the mobile device 504 can also be performed by wireless routers, repeaters, and/or other wireless communication devices with predetermined locations. In some configurations, the geolocation of the mobile device 504 can be produced by other mobile devices, for example if a second mobile device is acting as a relay, or “hotspot,” for the illustrated mobile device 504.

When the user 502 first enters a new area, the system can create a new profile tracking where the user 502 goes and visits. Preferably this information is anonymous, though in other configurations the identity of the user 502 may be known. As the user 502 visits other locations, the locations and associated metadata can also be stored in the database 508. For example, as the user 502 approaches Store A 512, the user 502 may cross a geofence 510 surrounding the store. The user 502 crossing the geofence 510 may be detected using surveillance cameras, motion detectors, and/or other detection devices, at which point data associated with that detection can be transmitted to the database 508 and associated with the user's profile. Exemplary data which can be recorded in the database 508 and associated with the profile of the user 502 for crossing the geofence 510 can include video surveillance footage, time, date, and/or a store type of Store A 512. Similar data can be saved if the user 502 crosses other geofences, such as the geofence 514 around Store B 516.

If the user 502 enters a store 512, 516, surveillance information from cameras or motion detectors at the entrance to the store can be uploaded to the database 520 and associated with the user profile. Examples of surveillance data can again include video surveillance footage, time, date, and/or a store type. If the user 502 makes a purchase in a store 512, 516, Point-of-Sale (POS) data associated with the sale can be uploaded to the database 508. Exemplary POS data can include identification of the item(s) purchased, time of purchase, purchase amount, etc.

Because the data being stored by the database 508 is from disparate data sources, the database may need to run various algorithms to identify characteristics of a given user. For example, if a cellular tower 506 were to have a user within its geographic boundary, then lose that user at the same time a signal is detected by a neighboring tower, the system can determine that those actions (the drop and subsequent addition), were the same user. Likewise, as users enter and leave various geofences 510, 514, the system can determine that the actions were performed by the same user (for example, because of entering and leaving various zones within various time periods).

In addition, the system may perform video analysis on the surveillance data collected, then combine that data with information about entering or leaving locations such as geofences and stores. For example, the system may record, in the database 508, video of a user crossing a geofence 510, 514. The system may perform video analysis of that video to identify the user crossing the boundary by their gender, clothing details (e.g., blue jeans and a black shirt), if they have bags in their hands, etc. When additional video of a user entering a store 512, 516 is recorded and analyzed, the system may identify similar characteristics in a user entering the store 512, 516 as the user that crossed the geofence 510, 514, and based on that similarity attach the video to the user's profile.

Likewise, as POS data is received, the system may not be able to immediately attach that information to any given user profile. However, when surveillance footage is received of a user leaving the store with an additional package, and the system had previously created a profile for that user, the system may attach the POS data to the user (in addition to recording the details about the user leaving the store).

As the database 508 collects data about the user 502, an Artificial Intelligence/ Suggestion Engine 518 can receive the data, analyze it, and make predictions about the behavior of the user 502. For example, if the user entered the geofence 510 around Store A 512, but did not enter Store A 512, entered Store B 514 (and the accompanying geofence 514) but did not make a purchase, the AI engine 518 may determine that the user 502 is interested in similar products to the products sold in Store B 514. At this point the AI engine 518 may not have enough information to know if the user 502 is looking for similar products to those in Store B 514 at a lower price, higher price, different quality, etc., but can begin providing suggestions to advertisers 520 about user 502. The advertisers 520 can send receive the suggestion of the AI/suggestion engine 518, along with any details about the user 502 stored in the database 508, and provide a customized advertisement or offer to the user 502.

In some cases, the customized offers or advertisements occur while the user 502 continues to shop, however preferably the customization occurs days or weeks after the user's 502 activity. As an example of realtime offers, a customized offer may be transmitted electronically to the user's mobile device 504 as the user 502 continues to shop. For example, the user's mobile device 504 may receive an offer of 10% off at a given store nearby based on the AI/suggestion engine's 518 suggestion. In other configurations, a customized advertisement can be displayed on an electronic poster or display within the shopping area. As an example of customizing advertising after the user 502 visits, the advertiser 520 may determine, based on the suggestion from the AI/suggestion engine 518 and/or data in the database 508, that the user 502 is a teenager, and modify an electronic poster nearby to show teenagers using a given product. In other instances, the advertiser 520 may determine that the user 502 is a parent shopping for multiple children, and modify the electronic poster to show a multiple children. On the user's 502 next visit to the shopping area the electronic poster will have changed.

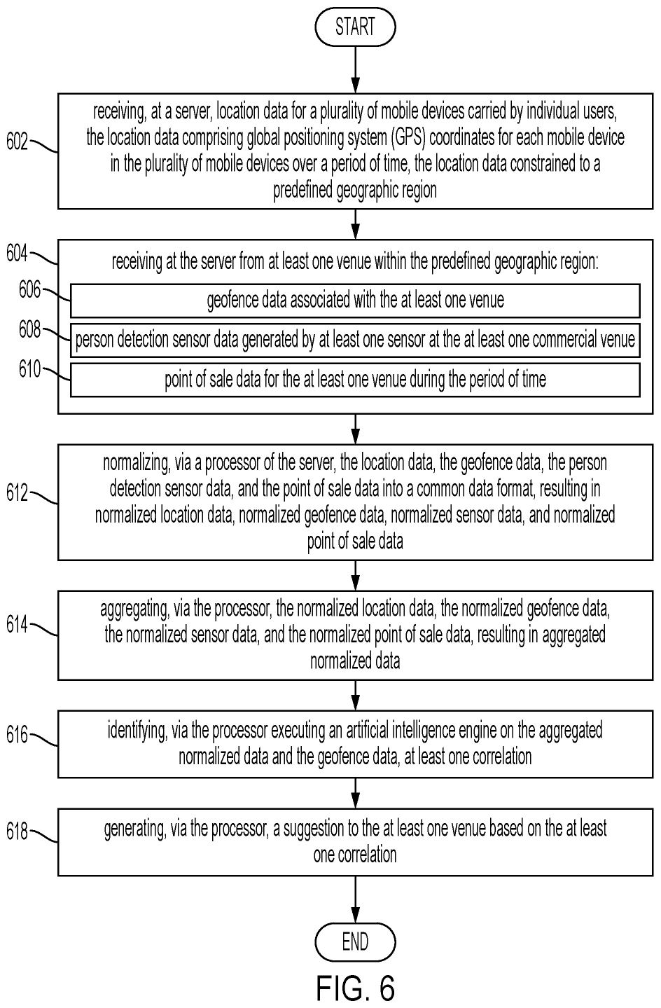

FIG. 6 illustrates an example method embodiment. In this example, a server is performing the method. The server receives location data for a plurality of mobile devices carried by individual users, the location data comprising global positioning system (GPS) coordinates for each mobile device in the plurality of mobile devices over a period of time, the location data constrained to a predefined geographic region (602). The server also receives, from at least one venue within the predefined geographic region (604): geofence data associated with the at least one venue (606), person detection sensor data generated by at least one sensor at the at least one commercial venue (608), and point of sale data for the at least one venue during the period of time (610). The server normalizes, via a processor of the server, the location data, the geofence data, the person detection sensor data, and the point of sale data into a common data format, resulting in normalized location data, normalized geofence data, normalized sensor data, and normalized point of sale data (612), and aggregates, via the processor, the normalized location data, the normalized geofence data, the normalized sensor data, and the normalized point of sale data, resulting in aggregated normalized data (614). The server then identifies, via the processor executing an artificial intelligence engine on the aggregated normalized data and the geofence data, at least one correlation (616), and generates, via the processor, a suggestion to the at least one venue based on the at least one correlation (618).

The at least one correlation can be at least one predicted human behavior. For example, the predicted human behavior can be related to an individual currently visiting the geographic area, or a projection of a fictional person based on how people who previously visited the geographic area.

In some configurations, the customized advertisement is transmitted from the server to a mobile device (such as a smartphone, cellphone, smartwatch, tablet, etc.) of an individual who visited the at least one venue.

In some configurations, the customized advertisement is transmitted from the server to an electronic poster (or billboard, or other electronic display) within the predefined geographic region.

In some configurations, the at least one correlation can include an ordered pattern of visitations to venues by a plurality of the individual users. In such configurations, the suggestion can be for a product to be sold at a venue based on the ordered pattern.

In some configurations, the artificial intelligence engine can perform operations including: weighting the aggregated normalized data based on previous data analyses, resulting in weighted aggregated normalized data; performing a plurality of regression analyses using the weighted aggregated normalized data, resulting in a plurality of regression results, wherein each regression analysis in the plurality of regression analyses use distinct aspects of the weighted aggregated normalized data; identifying the at least one correlation based on a commonality among the plurality of regression results; and modifying weights to be used in future executions of the artificial intelligence engine based on the at least one correlation.

In some configurations, the at least one venue can include a commercial venue selling a commercial product. For example, the commercial product can be a cannabis-based product.

In some configurations, the method illustrated can be further augmented to include receiving, at the server, third party map data identifying venues within the predefined geographic region, the venues including the at least one venue; normalizing the third party map data; and aggregating the third party map data into the aggregated normalized data.

In some configurations, the artificial intelligence engine can be trained by: receiving historical data which includes: historical locations of human beings at distinct points in time within the predefined geographic region; historical geofence data associated with the at least one commercial venue; historical person detection sensor data generated by the at least one sensor at the at least one commercial venue; and historical point of sale data for the at least one venue; executing a sensitivity analysis on the historical data, resulting in correlations between the historical data; generating, based on the correlations, a neural network comprising nodes and connections between the nodes, where the connections between the nodes are weighted based on the correlations; and converting the neural network to computer executable code, resulting in the artificial intelligence engine.

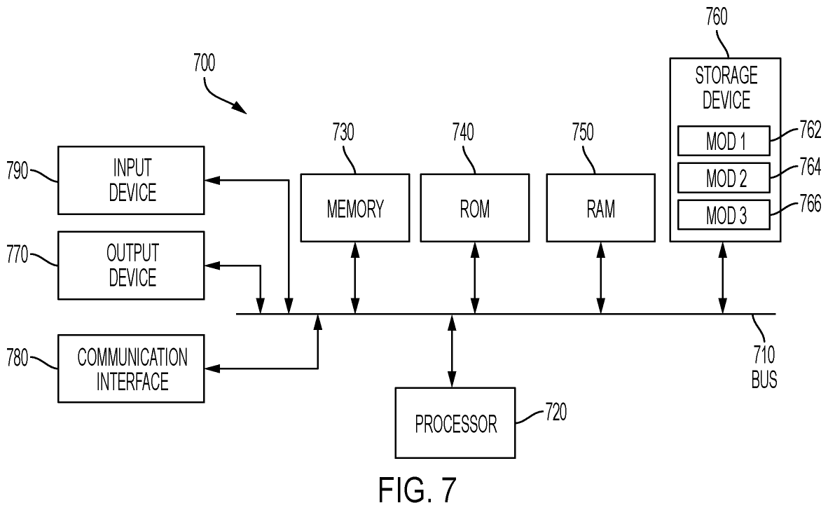

With reference to FIG. 7, an exemplary system includes a general-purpose computing device 700, including a processing unit (CPU or processor) 720 and a system bus 710 that couples various system components including the system memory 730 such as read-only memory (ROM) 740 and random access memory (RAM) 750 to the processor 720. The system 700 can include a cache of high-speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read-only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at a server, location data for a plurality of mobile devices carried by individual users, the location data comprising global positioning system (GPS) coordinates for each mobile device in the plurality of mobile devices over a period of time, the location data constrained to a predefined geographic region;
receiving at the server from at least one venue within the predefined geographic region:
geofence data associated with the at least one commercial venue;
person detection sensor data generated by at least one sensor at the at least one commercial venue; and
point of sale data for the at least one venue during the period of time;
normalizing, via a processor of the server, the location data, the geofence data, the person detection sensor data, and the point of sale data into a common data format, resulting in normalized location data, normalized geofence data, normalized sensor data, and normalized point of sale data;
aggregating, via the processor, the normalized location data, the normalized geofence data, the normalized sensor data, and the normalized point of sale data, resulting in aggregated normalized data;
identifying, via the processor executing an artificial intelligence engine on the aggregated normalized data and the geofence data, at least one predicted behavior of a human being;
generating, via the processor, a suggestion to the at least one venue based on the at least one predicted behavior of a human being; and
transmitting, from the server, a customized advertisement, where the customized advertisement is generated based on the suggestion.

2. The method of claim 1, wherein the customized advertisement is transmitted from the server to a mobile device of an individual who visited the at least one venue.

3. The method of claim 1, wherein the customized advertisement is transmitted from the server to an electronic poster within the predefined geographic region.

4. The method of claim 1, wherein the artificial intelligence engine performs operations comprising:
weighting the aggregated normalized data based on previous data analyses, resulting in weighted aggregated normalized data;
performing a plurality of regression analyses using the weighted aggregated normalized data, resulting in a plurality of regression results, wherein each regression analysis in the plurality of regression analyses use distinct aspects of the weighted aggregated normalized data;
identifying the at least one predicted behavior of a human being based on a commonality among the plurality of regression results; and
modifying weights to be used in future executions of the artificial intelligence engine based on the at least one predicted behavior of a human being.

5. The method of claim 1, wherein the at least one venue comprises a commercial venue selling a commercial product, wherein the commercial product is a cannabis-based product.

6. The method of claim 1, wherein the artificial intelligence engine is trained by:
receiving historical data comprising:
historical locations of human beings at distinct points in time within the predefined geographic region;
historical geofence data associated with the at least one commercial venue;
historical person detection sensor data generated by the at least one sensor at the at least one commercial venue; and
historical point of sale data for the at least one venue;
executing a sensitivity analysis on the historical data, resulting in correlations between the historical data;
generating, based on the correlations, a neural network comprising nodes and connections between the nodes, where the connections between the nodes are weighted based on the correlations; and
converting the neural network to computer executable code, resulting in the artificial intelligence engine.

7. The method of claim 1, further comprising:
receiving, at the server, third party map data identifying venues within the predefined geographic region, the venues including the at least one venue;
normalizing the third party map data; and
aggregating the third party map data into the aggregated normalized data.

8. A system comprising:
a processor; and
a non-transitory computer-readable storage medium having instructions stored which, when executed by the processor, cause the processor to perform operations comprising:
receiving, location data for a plurality of mobile devices carried by individual users, the location data comprising global positioning system (GPS) coordinates for each mobile device in the plurality of mobile devices over a period of time, the location data constrained to a predefined geographic region;
receiving from at least one venue within the predefined geographic region:
geofence data associated with the at least one commercial venue;
person detection sensor data generated by at least one sensor at the at least one commercial venue; and
point of sale data for the at least one venue during the period of time;
normalizing the location data, the geofence data, the person detection sensor data, and the point of sale data into a common data format, resulting in normalized location data, normalized geofence data, normalized sensor data, and normalized point of sale data;
aggregating the normalized location data, the normalized geofence data, the normalized sensor data, and the normalized point of sale data, resulting in aggregated normalized data;
identifying, by executing an artificial intelligence engine on the aggregated normalized data and the geofence data, at least one predicted behavior of a human being;
generating a suggestion to the at least one venue based on the at least one predicted behavior of a human being; and
transmitting a customized advertisement, where the customized advertisement is generated based on the suggestion.

9. The system of claim 8, wherein the at least one predicted behavior of a human being comprises an ordered pattern of visitations to venues by a plurality of the individual users.

10. The system of claim 9, wherein the suggestion is for a product to be sold at a venue based on the ordered pattern.

11. The system of claim 8, wherein the artificial intelligence engine performs operations comprising:
weighting the aggregated normalized data based on previous data analyses, resulting in weighted aggregated normalized data;
performing a plurality of regression analyses using the weighted aggregated normalized data, resulting in a plurality of regression results, wherein each regression analysis in the plurality of regression analyses use distinct aspects of the weighted aggregated normalized data;
identifying the at least one predicted behavior of a human being based on a commonality among the plurality of regression results; and
modifying weights to be used in future executions of the artificial intelligence engine based on the at least one predicted behavior of a human being.

12. The system of claim 8, wherein the at least one venue comprises a commercial venue selling a commercial product.

13. The system of claim 12, wherein the commercial product is a cannabis-based product.

14. The system of claim 8, the non-transitory computer-readable storage medium having additional instructions stored which, when executed by the processor, cause the processor to perform operations comprising:
receiving third party map data identifying venues within the predefined geographic region, the venues including the at least one venue;
normalizing the third party map data; and
aggregating the third party map data into the aggregated normalized data.

15. A non-transitory computer-readable storage medium having instructions stored which, when executed by a computing device, cause the computing device to perform operations comprising:
receiving, location data for a plurality of mobile devices carried by individual users, the location data comprising global positioning system (GPS) coordinates for each mobile device in the plurality of mobile devices over a period of time, the location data constrained to a predefined geographic region;
receiving from at least one venue within the predefined geographic region:
geofence data associated with the at least one commercial venue;
person detection sensor data generated by at least one sensor at the at least one commercial venue; and
point of sale data for the at least one venue during the period of time;
normalizing the location data, the geofence data, the person detection sensor data, and the point of sale data into a common data format, resulting in normalized location data, normalized geofence data, normalized sensor data, and normalized point of sale data;
aggregating the normalized location data, the normalized geofence data, the normalized sensor data, and the normalized point of sale data, resulting in aggregated normalized data;
identifying, by executing an artificial intelligence engine on the aggregated normalized data and the geofence data, at least one predicted behavior of a human being;
generating a suggestion to the at least one venue based on the at least one predicted behavior of a human being; and
transmitting, to an electronic poster, a customized advertisement, where the customized advertisement is generated based on the suggestion.

16. The non-transitory computer-readable storage medium of claim 15, wherein the at least one predicted behavior of a human being comprises an ordered pattern of visitations to venues by a plurality of the individual users.

17. The non-transitory computer-readable storage medium of claim 16, wherein the suggestion is for a product to be sold at a venue based on the ordered pattern.

18. The non-transitory computer-readable storage medium of claim 15, wherein the artificial intelligence engine performs operations comprising:
weighting the aggregated normalized data based on previous data analyses, resulting in weighted aggregated normalized data;
performing a plurality of regression analyses using the weighted aggregated normalized data, resulting in a plurality of regression results, wherein each regression analysis in the plurality of regression analyses use distinct aspects of the weighted aggregated normalized data;
identifying the at least one predicted behavior of a human being based on a commonality among the plurality of regression results; and
modifying weights to be used in future executions of the artificial intelligence engine based on the at least one predicted behavior of a human being.

19. The non-transitory computer-readable storage medium of claim 15, wherein the at least one venue comprises a commercial venue selling a commercial product.

20. The non-transitory computer-readable storage medium of claim 19, wherein the commercial product is a cannabis-based product.
